(19) United States
(12) Patent Application Publication
(10) Pub. No.: US 2008/0145672 A1
(43) Pub. Date: Jun. 19, 2008

(54) Injection molding of ceramic elements

(75) Inventors: Craig A. Willkens, Sterling, MA (US); Taehwan Yu, Sudbury, MA (US); Suresh Annavarapu, Somerville, MA (US)

Correspondence Address: EDWARDS ANGELL PALMER & DODGE LLP, P.O. BOX 55874, BOSTON, MA, 02205, US

(73) Assignee: Saint-Gobain Ceramics & Plastics, Inc., Worcester, MA (US)

(21) Appl. No.: 11/894,047

(22) Filed: Aug. 16, 2007

Related U.S. Application Data
(60) Provisional application No. 60/838,652, filed on Aug. 16, 2006.

(51) Int. Cl. B32B 18/00; B29D 11/00; B29D 31/00; B29C 45/16

(52) U.S. Cl. 428/426; 264/328.8; 264/250; 264/104; 264/1.21; 264/129; 264/232; 264/138

(57) ABSTRACT

New methods are provided for manufacture ceramic elements that include injection molding of two, three or more distinct ceramic layers or regions that form the element. Ceramic elements also are provided that are obtainable from fabrication methods of the invention.

The present application claims the benefit of U.S. application No. 60/838,652 filed Aug. 16, 2006, which is incorporated herein by reference in its entirety.

### BACKGROUND

1. Field of the Invention

The present invention includes new methods for manufacture ceramic elements that include injection molding of two, three or more distinct ceramic regions that form the element. Ceramic elements also are provided obtainable from fabrication methods of the invention are provided.

2. Background

Ceramic materials have been widely used for numerous application, including in semiconductor devices, electrically functional elements or devices, opto-electric devices, mechanical or support elements and other functional elements such as to transmit or detect thermally, optically or electrically. See, for instance, U.S. Pat. Nos. 4,919,609; 4,994,418; 5,064,684; 6,278,087; 6,582,629; 6,653,557; 6,702,466; 6,830,221; 6,888,169; 6,890,874; and 6,908,872 and U.S. Published Applications 2002/0109152; 2003/0165303; and 2006/0140534.

Fabrication of such elements can be difficult, including in situations where multiple ceramic materials are employed in a fabrication process. Significant device geometries or topographies also can pose notable fabrication challenges.

It thus would be particularly to have new methods for producing ceramic elements.

### SUMMARY

New methods for producing ceramic devices or elements are now provided which include injection molding of ceramic material to thereby form the ceramic element. Such injection molding fabrication can provide enhanced output and cost efficiencies relative to prior approaches as well as provide devices of good mechanical strength.

More particularly, preferred methods of the invention include injection molding of two or more distinct layers or regions to form a ceramic element. Particularly preferred methods include injection molding three or more distinct layers or regions of the ceramic element.

The distinct layers or regions of a ceramic element that may be injection molded may differ in one or more respects. For instance, distinct ceramic compositions may be injection molded to form distinct regions of the ceramic element. Distinct ceramic compositions may comprise one or more different ceramic materials (e.g. SiC, metal oxides such as Al₂O₃, nitrides such as AlN, Mo₂Si₂ and other Mo-containing materials, SiAlON, Ba-containing material, and the like). Alternatively, distinct ceramic compositions may comprise the same blend of ceramic materials (e.g. a binary, ternary or higher order blend of distinct ceramic materials), but where the relative amounts of those blend members differ, e.g. where one or more blend members differ by at least 5, 10, 20, 25 or 30 volume percent between the respective distinct ceramic compositions.

The distinct layers or regions of a ceramic element that may be injection molded also may differ in functional properties, for example, the distinct regions may differ in electrical resistivity, optical transmission, thermal expansion characteristics, and/or hardness.

For instance, in preferred systems, a ceramic element region (first region) may be considered as differing in resisitivity from another region of the element (second region) if the first and second regions have a difference in room temperature resisitivity of least 10 or 10² ohms-cm, or more suitably a difference in room temperature resisitivity of least 10³ or 10⁴ ohms-cm.

In preferred systems, a ceramic element region (first region) may be considered as differing in thermal expansion characteristics from another region of the element (second region) if the first and second regions have a difference in coefficients of thermal expansion of at least about 0.1×10⁻⁶ K⁻¹, more typically a difference in coefficients of thermal expansion of at least about 0.2×10⁻⁶ K⁻¹, or a difference in coefficients of thermal expansion of at least about 0.5×10⁻⁶ K⁻¹, or a difference in coefficients of thermal expansion of at least about 1×10⁻⁶ K⁻¹, or a difference in coefficients of thermal expansion of at least about 2 or 3×10⁻⁶ K⁻¹, between distinct ceramic regions of an element.

Two or more of the injected molded element portions also may be distinctly positioned within the element, for instance, the two or more regions may be positioned at opposing angles, e.g. where the longest dimension of the multiple portions are offset with respect to each other by angles of 20, 30, 40, 50, 60, 70, 80, 90, 120, 150 or 180 degrees or more.

In preferred aspects of the invention, at least two or three portions of a ceramic element are injection molded in single fabrication sequence to produce a ceramic component, a so-called “multiple shot” injection molding process where, in the same fabrication sequence, multiple portions of a ceramic element having different ceramic composition and/or functional properties are injection molded to form an element. In at least certain embodiments, a single fabrication sequence includes sequential injection molding applications of a ceramic material without removal of the element from the element-forming area and/or without deposition of ceramic material to an element member by a process other than injection molding.

For instance, in one aspect, a first region or portion can be injection molded, around that first portion a second portion that extends in the same plane but at an opposed angle with respect to the first portion then can be injection molded in a second step, and in a third step a third region can be applied by injection molding to the body containing the first and second portion. The third portion can be positioned in a distinct plane and/or at opposing angle with respect to one or both of the first and second portions.

Good mating of adjacent deposited ceramic composition regions can facilitate formation of a multiple region element. In particular, for injection molding three or more portions of an element (i.e. so-called three-shot or other order higher injection molding process), good mating of the third (or further subsequent) injection molded portion with previously deposited first and second portions can be important to ensure that a uniform and effective element is produced. That is, desired performance results of the produced ceramic element can be further ensured by accurate placement of the third or further injection molded portion of the element with respect to previously deposited element portions.

Good mating of the second, third or further injection molded portions of the ceramic element can be facilitated by effective air removal from the site where the ceramic material is being deposited via injection molding. For example, effective venting (removal) of air from the deposition site can aid good mating of the ceramic material being deposited with previously deposited ceramic element portions. Such venting can be accomplished by various methods, including maintaining a slight negative pressure (vacuum line) in the general area that ceramic material is being deposited.

It also has been found that injection molding deposition of second, third and further higher order portions should be done whereby previously deposited element portions are not deformed to thereby maintain the structural integrity of the produced element.

Fabrication methods of the invention may include further processes for addition of ceramic or other material to produce the formed ceramic element, which further processes do not involve injection molding. For instance, one or more ceramic layers or regions may be applied to a formed element such as by dip coating, spray coating and the like of a ceramic composition slurry. Non-ceramic materials also may be applied to an element body such as application of a metallic composition, which may be deposited by a dip coating process, sputtering or other procedure.

The formed element may be additionally processed as desired. In particular, the formed element comprising ceramic portions may have the ceramic regions densified (sintered) such as under conditions of elevated heat and pressure. Various areas of the formed element also may be removed such as by drilling or other process so as to expose an underlayer region or to provide a void region.

Methods of the invention may be utilized to produce a variety of devices that comprise one or more ceramic elements as disclosed herein. That is, the invention also includes devices and elements obtainable or obtained through use of an injection molding method disclosed herein.

More particularly, for instance, the invention includes devices that may comprise a bearing, support or structural element; electrical connection element; a shielding element; a thermal or gas (e.g. oxygen) sensor; or optical sensor device, which may suitably comprise one or more ceramic elements as disclosed herein. In certain aspects, a semiconductor device, opto-electronic device or sensing element my comprise one or more ceramic elements as disclosed herein.

Particularly preferred ceramic bearing, support or structural elements may comprise multiple, distinct ceramic regions (e.g. two, three, four or more distinct regions), where those multiple regions have distinct coefficients of thermal expansion (CTE). Those multiple regions are formed by multiple injection molding depositions of distinct ceramic compositions. By providing a CTE gradient in the formed bearing element, the element can exhibit improved fatigue life as well as resistance to compression-induced cracking or other such degradation.

Particularly preferred ceramic bearing, support or structural elements also may include elements that comprise multiple, distinct ceramic regions (e.g. two, three, four or more distinct regions), where those multiple regions have distinct densities, for example, a relatively lower density ceramic region(s) in interior or core areas of the element with encapsulating or outer ceramic region(s) that have a relatively higher density than the inner region(s).

Preferred ceramic bearing, support or structural elements also may include elements that comprise multiple, distinct ceramic regions (e.g. two, three, four or more distinct regions), where those multiple regions have distinct hardness, for example, a relatively softer ceramic region(s) in interior or core areas of the element (e.g. a predominately metal oxide core region such as an alumina core region) with encapsulating or outer ceramic regions(s) that have a relatively greater hardness such as a nitride outer region(s), e.g. an outer region that contains silicon nitride.

Additional preferred elements and devices of the invention include piezo-ceramic components which may be produced through multiple injection molding fabrication as disclosed herein. For instance, such preferred devices may comprise an active piezo element integrated with one or more conductive ceramic regions that can function as one or more electrodes. Further preferred devices of the invention include piezoelectric actuators that comprise multiple distinct ceramic regions as disclosed herein.

As discussed above, preferred devices of the invention also include sensor devices, such as oxygen sensor device which may include a ceramic heater element, or a flame sensor device that is integrated with a ceramic heating element.

Additional preferred devices of the invention include microfluidic devices that comprises multiple, distinct ceramic regions as disclosed herein. Such devices may comprise for example one or more channels for delivery of fluid samples and electrical and/or optical functions for analysis of fluid samples.

Also preferred are gas injectors devices that include multiple ceramic regions as disclosed herein. For instance, a preferred gas injector may comprise one or more inner ceramic regions (e.g. an inner region comprising one or more metal oxides such as alumina) that may be coated or encapsulated with ceramic composition to provide protection to the inner regions from aggressive environments. In one preferred aspect, a gas injector may have one or more inner regions that comprise one or more metal oxides such as alumina that is then encapsulated at least in part with a protective ceramic region that comprises e.g. yttria.

Devices of the invention also include electric static discharge devices which comprise multiple, distinct ceramic regions as disclosed herein. The invention also includes jewelry elements or articles which comprise multiple, distinct ceramic regions as disclosed herein.

In at least certain embodiments, the formed ceramic element or device does not comprise a resistive heating element such as a ceramic ignition element.

Other aspects of the invention are disclosed infra.

### BRIEF DESCRIPTION OF THE DRAWINGS

FIG. 1 shows schematically a bearing element in accordance with the invention;

FIG. 2 shows a heating element in accordance with the invention of the invention;

FIG. 3 shows a flame rod element in accordance with the invention;

FIG. 4 shows a thermal electric element in accordance with the invention;

FIG. 5. shows a cutting blade system in accordance with the invention; and

FIG. 6 shows a piezoelectric ceramic element.

### DETAILED DESCRIPTION

As discussed above, new methods are now provided for producing ceramic elements that include injection molding of one or more layers or regions of the element.

As typically referred to herein, the term “injection molded,” “injection molding” or other similar term indicates the general process such as where a material (here a ceramic or pre-ceramic material) is injected or otherwise advanced typically under pressure into a mold in the desired shape of the ceramic element typically followed by cooling and subsequent removal of the solidified element that retains a replica of the mold.

In injection molding formation of elements of the invention, a ceramic material (such as a ceramic powder mixture, dispersion or other formulation) or a pre-ceramic material or composition may be advanced into a mold element.

In suitable fabrication methods of the invention, an integral element having regions of differing resistivities may be formed by sequential injection molding of ceramic or pre-ceramic materials having differing resisitivities.

Thus, for instance, a base element may be formed by injection introduction of a material having a first resisitivity into a mold element that defines a desired base shape such as a rod shape. The base element may be removed from such first mold and positioned in a second, distinct mold element and ceramic material having differing resistivity—e.g. a conductive ceramic material—can be injected into the second mold to provide conductive region(s) of the element. In similar fashion, the base element may be removed from such second mold and positioned in a yet third, distinct mold element and ceramic material having differing resistivity—e.g. a resistive hot zone ceramic material—can be injected into the third mold to provide higher resistivity region(s) of the element.

A base ceramic element may comprise additional distinct ceramic composition regions, including four or five or more distinct regions. For instance, such an element is disclosed in U.S. Patent Application Publication 2002/0150851 to Willkens, which describes ceramic igniters having four ceramic regions of distinct electrical resistivity (conductive region of relatively low resistance, a power booster or enhancement zone of intermediate resistance, a heat sink region of distinct resistance, and a hot or ignition zone of relatively high electrical resistance). Those multiple, distinct regions may be produced by a plurality of multiple injection molding steps as disclosed herein.

Also, rather than use of a plurality of distinct mold elements as discussed above, differing ceramic materials may be sequentially advanced or injected into the same mold element. For instance, a predetermined volume of a first ceramic material may be introduced into a mold element that defines a desired base shape and thereafter a second ceramic material of differing resisitivity may be applied to the formed base.

Ceramic material may be advanced (injected) into a mold element as a fluid formulation that comprises one or more ceramic materials such as one or more ceramic powders.

For instance, a slurry or paste-like composition of ceramic powders may be prepared, such as a paste provided by admixing one or more ceramic powders with an aqueous solution or an aqueous solution that contains one or more miscible organic solvents such as alcohols and the like. A preferred ceramic slurry composition for extrusion may be prepared by admixing one or more ceramic powders such as MoSi₂, SiC, Al₂O₃, and/or AlN in a fluid composition of water optionally together with one or more organic solvents such as one or more aqueous-miscible organic solvents such as a cellulose ether solvent, an alcohol, and the like. The ceramic slurry also may contain other materials e.g. one or more organic plasticizer compounds optionally together with one or more polymeric binders.

A wide variety of shape-forming or inducing elements may be employed to form an element, with the element of a configuration corresponding to desired shape of the formed element. For instance, to form a rod-shaped element, a ceramic powder paste may be injected into a cylindrical die element. To form a stilt-like or rectangular-shaped element, a rectangular die may be employed.

After advancing ceramic material(s) into a mold element, the defined ceramic part suitably may be dried e.g. in excess of 50° C. or 60° C. for a time sufficient to remove any solvent (aqueous and/or organic) carrier.

As mentioned above, it has been found that results and quality of the produced element can be enhanced by good mating of the multiple injection molded ceramic regions, including good mating of the third (or further subsequent) injection molded portion with previously deposited first and second portions. In addition to accurate placement of subsequently molded portions, mating of characteristics of adjacent distinct ceramic regions can ensure a higher quality formed element. For instance, it can desirable that the binder compositions used for ceramic compositions of distinct regions are similar in components, viscosity and other characteristics.

It also can be desirable that the first deposited ceramic composition region have a relatively enhanced structural integrity as applied in a green state with binder composition to be thereby resistant to deformation upon injection molding of subsequent, adjoining ceramic regions. For instance, the first deposited ceramic composition may comprise a binder additive such as a polymer e.g. polypropylene that can provide greater structural integrity to the deposited ceramic region. The first deposited region also may be formed with topography (e.g. cross-hatched surface) that will mate with and provide good adherence to a subsequently applied adjacent ceramic region.

As discussed above, good mating of the second, third or further injection molded portions of the ceramic element can be facilitated by effective air removal from the site where the ceramic material is being deposited via injection molding. For example, effective venting (removal) of air from the deposition site can aid good mating of the ceramic material being deposited with previously deposited ceramic element portions. Such venting can be accomplished by various methods, including maintaining a slight negative pressure (vacuum line) in the general area that ceramic material is being deposited. Additionally, delivery speed of the ceramic material should not exceed a level where effective air removal is inhibited.

It also has been found that injection molding deposition of second, third and further higher order portions should be done whereby previously deposited element portions are not deformed to thereby maintain the structural integrity of the produced element.

The examples which follow describe preferred injection molding processes.

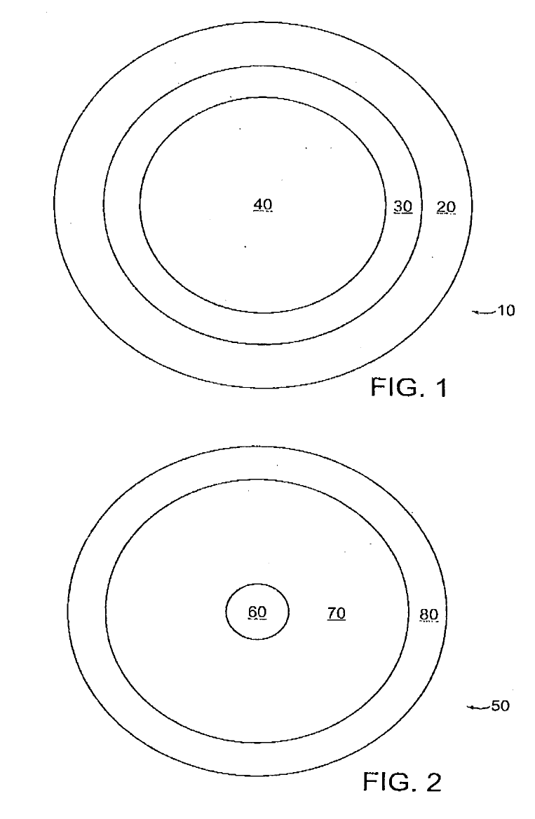

Referring now to the drawings, FIG. 1 shows in schematic cross-section a bearing element 10 with multiple, distinct ceramic regions 20, 30 and 40 that each differ in thermal expansion characteristics (i.e. differing coefficients of thermal expansion (CTE)), for instance where outer region 10 has a relatively low CTE, middle region 20 has an intermediate relative CTE value, and inner or core region 30 has the highest relative CTE value of the element.

FIG. 2 shows in a schematic top view a heater plate element 50 which includes concentric ceramic regions 60, 70 and 80. Heater plate element 50 may be for example a cigarette lighter for a motor vehicle. As depicted in FIG. 2, heater plate element 50 may comprise conductive zones 60 and 80 with an interposed resistive (hot) zone 70.

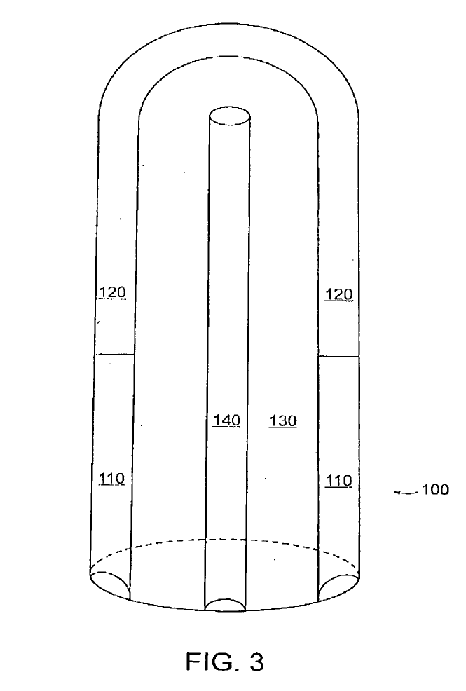

FIG. 3 shows schematically a ceramic flame rod or flame rectifier 100 which comprises multiple, distinct ceramic regions 110, 120 and 140. Region 110 is electrically conductive and region 120 is a resistive (hot) zone to provide a heating element particularly an igniter. Flame detection element 140 is spaced from regions 110 and 120 by void area 130. Detection element 140 is suitably a conductive ceramic region which in use forms a circuit between a flame and ground.

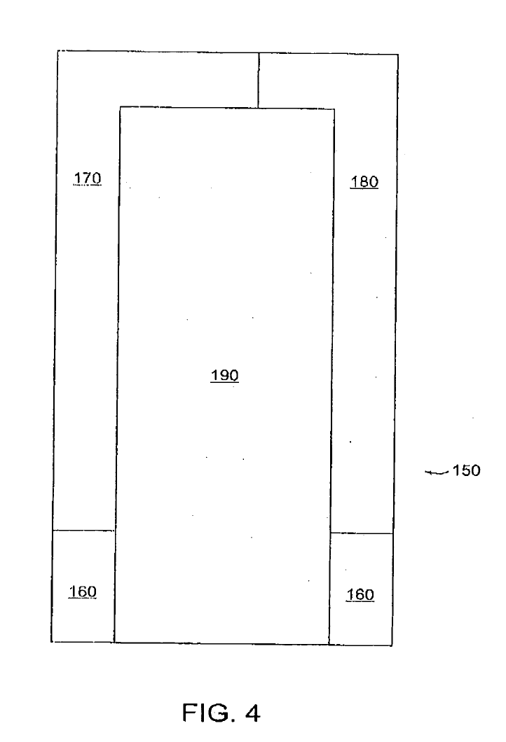

FIG. 4 shows schematically thermal electric ceramic element 150 which includes multiple, distinct ceramic regions of conductor regions 160, N-type region 170, P-type region 180 and support portion 190.

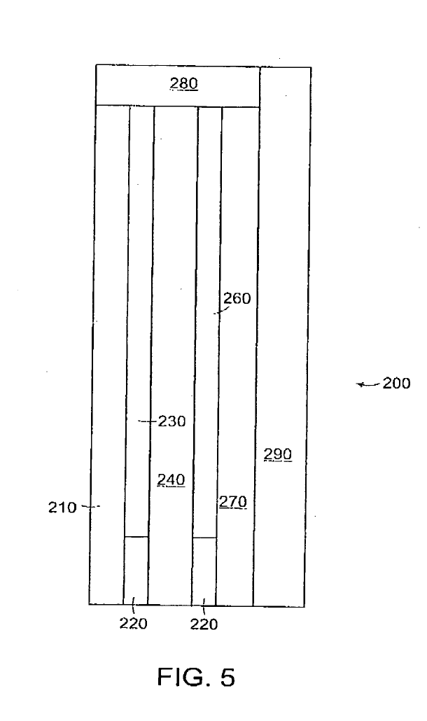

FIG. 5 shows schematically a heated cutting blade 200 which comprises multiple, distinct ceramic regions of insulating regions 210, 240 and 270, conductive regions 220 and 280, resistive (hot) regions of 230 and 260, and cutting surface 290 (which suitably would be an insulating composition).

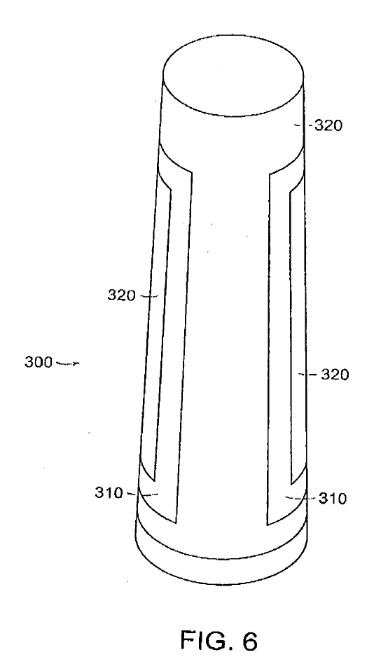

FIG. 6 shows a piezoelectric ceramic element 300 which may include multiple, distinct ceramic regions. Piezoelectric ceramic element 300 may be suitably a piezoelectric ceramic oscillator rod element which includes electrode regions 310 and piezoelectric ceramic rod regions 320. Such an element 300 may be suitably a component of a ceramic gyro device (which can detect various movement) where the vibrating element comprises a cylindrical piezoelectric ceramic oscillator rod 300. In use of certain systems, when voltage is applied to the piezoelectric ceramic oscillator rod, the rod torsionally vibrates. When the rod 300 rotates, the rod can output voltage in proportion to the rotational velocity.

As discussed above, the elements and devices depicted in FIGS. 1 through 6 are produced through injection molding of multiple ceramic compositions to form the element. Once the element is formed by such injection molding processing, the element may be further processed as desired. For example, the formed element may be further densified such as under conditions that include elevated temperature and pressure.

Additionally, ceramic regions of differing composition or properties (e.g. differing resistivity) may be applied to a formed base element by procedures other than injection molding, e.g. a base element may be dip coated in a ceramic composition slurry to provide a region with appropriate masking of device regions as desired. For such dip coating applications, a slurry or other fluid-like composition of the ceramic composition may be suitably employed. The slurry may comprise water and/or polar organic solvent carriers such as alcohols and the like and one or more additives to facilitate the formation of a uniform layer of the applied ceramic composition. For instance, the slurry composition may comprise one or more organic emulsifiers, plasticizers, and dispersants. Those binder materials may be suitably removed thermally during subsequent densification of the ceramic element.

Significantly, methods of the invention can facilitate fabrication of ceramic elements and devices of a variety of configurations as may be desired for a particular application. To provide a particular configuration, an appropriate shape-inducing mold element is employed through which a ceramic composition (such as a ceramic paste) may be injected.

A wide variety of ceramic compositions may be employed to form elements of the invention. For instance, as discussed above, ceramic compositions of differing resistivies may be employed in a particular element. Generally preferred highly resistive (hot) zone or region ceramic compositions comprise two or more components of 1) conductive material; 2) semiconductive material; and 3) insulating material. Conductive (cold) and insulative (heat sink) regions may be comprised of the same components, but with the components present in differing proportions. Typical conductive materials include e.g. molybdenum disilicide, tungsten disilicide, nitrides such as titanium nitride, and carbides such as titanium carbide. Typical semiconductors include carbides such as silicon carbide (doped and undoped) and boron carbide. Typical insulating materials include metal oxides such as alumina or a nitride such as AlN and/or Si₃N₄.

As referred to herein, the term electrically insulating material indicates a material having a room temperature resistivity of at least about 10¹⁰ ohms-cm. The electrically insulating material component of elements of the invention may be comprised solely or primarily of one or more metal nitrides and/or metal oxides, or alternatively, the insulating component may contain materials in addition to the metal oxide(s) or metal nitride(s). For instance, the insulating material component may additionally contain a nitride such as aluminum nitride (AlN), silicon nitride, or boron nitride; a rare earth oxide (e.g. yttria); or a rare earth oxynitride. A preferred added material of the insulating component is aluminum nitride (AlN).

As referred to herein, a semiconductor ceramic (or “semiconductor”) is a ceramic having a room temperature resistivity of between about 10 and 10⁸ ohm-cm. If the semiconductive component is present as more than about 45 v/o of a hot zone composition (when the conductive ceramic is in the range of about 6-10 v/o), the resultant composition becomes too conductive for high voltage applications (due to lack of insulator). Conversely, if the semiconductor material is present as less than about 10 v/o (when the conductive ceramic is in the range of about 6-10 v/o), the resultant composition becomes too resistive (due to too much insulator). Again, at higher levels of conductor, more resistive mixes of the insulator and semiconductor fractions are needed to achieve the desired voltage. Typically, the semiconductor is a carbide from the group consisting of silicon carbide (doped and undoped), and boron carbide. Silicon carbide is generally preferred.

As referred to herein, a conductive material is one which has a room temperature resistivity of less than about 10⁻² ohm-cm. If the conductive component is present in an amount of more than 35 v/o of the hot zone composition, the resultant ceramic of the hot zone composition, the resultant ceramic can become too conductive. Typically, the conductor is selected from the group consisting of molybdenum disilicide, tungsten disilicide, and nitrides such as titanium nitride, and carbides such as titanium carbide. Molybdenum disilicide is generally preferred.

In general, preferred hot (resistive) zone compositions include (a) between about 50 and about 80 v/o of an electrically insulating material having a resistivity of at least about 10¹⁰ ohm-cm; (b) between about 0 (where no semiconductor material employed) and about 45 v/o of a semiconductive material having a resistivity of between about 10 and about 10⁸ ohm-cm; and (c) between about 5 and about 35 v/o of a metallic conductor having a resistivity of less than about 10⁻² ohm-cm. Preferably, the hot zone comprises 50-70 v/o electrically insulating ceramic, 10-45 v/o of the semiconductive ceramic, and 6-16 v/o of the conductive material. For at least certain applications, a specifically preferred hot zone composition contains 10 v/o MoSi₂, 20 v/o SiC and balance AlN or Al₂O₃.

Preferred cold or conductive zone regions include those that are comprised of e.g. AlN and/or Al₂O₃ or other insulating material; SiC or other semiconductor material; and MoSi₂ or other conductive material. However, cold zone regions will have a significantly higher percentage of the conductive and semiconductive materials (e.g., SiC and MoSi₂) than the hot zone. For at least certain applications, a preferred cold zone composition comprises about 15 to 65 v/o aluminum oxide, aluminum nitride or other insulator material; and about 20 to 70 v/o MoSi₂ and SiC or other conductive and semiconductive material in a volume ratio of from about 1:1 to about 1:3. For many applications, more preferably, the cold zone comprises about 15 to 50 v/o AlN and/or Al₂O₃, 15 to 30 v/o SiC and 30 to 70 v/o MoSi₂. For ease of manufacture of a particular element, preferably the cold zone composition is formed of the same materials as the hot zone composition, with the relative amounts of semiconductive and conductive materials being greater. For certain application, a specifically preferred cold zone composition contains 20 to 35 v/o MoSi₂, 45 to 60 v/o SiC and balance either AlN and/or Al₂O₃.

Insulative ceramic regions of an element may mate with a conductive zone or a hot zone, or both. Preferably, a sintered insulator region has a resistivity of at least about 10¹⁴ ohm-cm at room temperature and a resistivity of at least 10⁴ ohm-cm at operational temperatures and has a strength of at least 150 MPa. Preferably, an insulator region has a resistivity at operational (ignition) temperatures that is at least 2 orders of magnitude greater than the resistivity of the hot zone region. Suitable insulator compositions comprise at least about 90 v/o of one or more aluminum nitride, alumina and boron nitride. For certain applications, a specifically preferred insulator composition consists of 60 v/o AlN; 10 v/o Al₂O₃; and balance SiC.

The following non-limiting examples are illustrative of the invention. All documents mentioned herein are incorporated herein by reference in their entirety.

### EXAMPLE 1

### Device Fabrication

Powders of a resistive composition (22 vol % MoSi₂, remainder Al₂O₃) and an insulating composition (100 vol % Al₂O₃) were mixed with an organic bonder (about 6-8 wt % vegetable shortening, 2.4 wt % polystyrene and 2-4 wt % polyethylene) to form two pastes with about 62 vol % solids. The two pastes were loaded into two barrels of a co-injection molder. A first shot filled a half-cylinder shaped cavity with insulating paste forming the supporting base with a fin running along the length of the cylinder. The part was removed from the first cavity, placed in a second cavity and a second shot filled the volume bounded by the first shot and the cavity wall core with the conductive paste. The molded part which forms a hair-pin shaped conductor with insulator separating the two legs. The rod was then partially debindered at room temperature in an organic solvent dissolving out 10 wt % of the added 10-16 wt %. The part was then thermally debindered in flowing inert gas (N₂) at 300-500° C. for 60 hours to remove the remainder of the residual binder. The debindered part was densified to 95-97% of theoretical at 1800-1850° C. in Argon. The densified part was cleaned up by grit-blasting. When the two legs of the igniter device are connected to a power supply at a voltage of 36V, the hot-zone attained at temperature of about 1300° C.

### EXAMPLE 2

### Additional Device Fabrication

Powders of a resistive composition (22 vol % MoSi₂, remainder Al₂O₃) and an insulating composition (5 vol % SiC, remainder Al₂O₃) were mixed with an organic bonder (about 6-8 wt % vegetable shortening, 2.4 wt % polystyrene and 2-4 wt % polyethylene) to form two pastes with about 62 vol % solids. The two pastes were loaded into two barrels of a co-injection molder. A first shot filled a half-cylinder shaped cavity with insulating paste forming the supporting base with a fin running along the length of the cylinder. The part was removed from the first cavity, placed in a second cavity and a second shot filled the volume bounded by the first shot and the cavity wall core with the conductive paste. The molded part which forms a hair-pin shaped conductor with insulator separating the two legs. The rod was then partially debindered at room temperature in an organic solvent dissolving out 10 wt % of the added 10-16 wt %. The part was then thermally debindered in flowing inert gas such as N₂ at 300-500° C. for 60 hours to remove the remainder of the residual binder. The debindered parts were densified to 95-97% of theoretical at 1800-1850° C. in Argon. Densified parts were cleaned up by grit-blasting. When the two legs of the igniters are connected to a power supply at voltages ranging from of 120V, the hot-zone attained at temperature of about 1307° C.

### EXAMPLE 3

### Additional Device Fabrication

Powders of a resistive composition (22 vol % MoSi₂, 20 vol % SiC, remainder Al₂O₃) and an insulating composition (20 vol % SiC, remainder Al₂O₃) were mixed with about 15 wt % polyvinyl alcohol to form two pastes with about 60 vol % solids. The two pastes were loaded into two barrels of a co-injection molder. A first shot filled a cavity that had an hour-glass shaped cross-section with insulating paste forming the supporting base. The part was removed from the first cavity, placed in a second cavity and a second shot filled the volume bounded by the first shot and the cavity wall core with the conductive paste. The molded part which forms a hair-pin shaped conductor with insulator separating the two legs was then partially debindered in tap water dissolving out 10 wt % of the added 10-16 wt %. The part was then thermally debindered in flowing inert gas (N₂) at 500° C. for 24 h to remove the remainder of the residual binder. The debindered part was densified to 95-97% of theoretical at 1800-1850° C. in Argon. The densified part was cleaned up by grit-blasting. When the two legs of the igniter are connected to a power supply at a voltage of 48V, the hot-zone attained at temperature of about 1300° C.

### EXAMPLE 4

### Further Device Fabrication

Powders of a resistive composition (20 vol % MoSi₂, 5 vol % SiC, 74 vol % Al₂O₃ and 1 vol % Gd₂O₃), a conductive composition (28 vol % MoSi₂, 7 vol % SiC, 64 vol % Al₂O₃ and 1 vol % Gd₂O₃) and an insulating composition (10 vol % MoSi₂, 89 vol % Al₂O₃ and 1 vol % Gd₂O₃) were mixed with 10-16 wt % organic binder (about 6-8 wt % vegetable shortening, 2-4 wt % polystyrene and 2-4 wt % polyethylene) to form three pastes with about 62-64 vol % solids loading. The three pastes were loaded into the barrels of a co-injection molder. A first shot filled a cavity that had an hour-glass shaped cross-section with the insulating paste forming the supporting base. The part was removed from the first cavity and placed in a second cavity. A second shot filled the bottom half of the volume bounded by the first shot and the cavity wall with the conductive paste. The part was removed from the second cavity and placed in a third cavity. A third shot filled the volume bounded by the first shot, second shot and the cavity wall with resistive paste forming a hair-pin shaped resistor separated by the insulator and connected to conductive legs also separated by the insulator. The molded part was the partially debindered in n-propyl bromide dissolving out 10 wt % of the added 10-16 wt %. The part was then thermally debindered in slowing Ar or N₂ at 500° C. for 24 h to remove the remaining binder and densified to 95-97% of theoretical at 1750° C. in Argon at 1 atm pressure. When the two conductive legs of the igniter are connected to a power supply of a voltage of 120V, the hot-zone (i.e. the resistive zone) attained a temperature of 1300° C.

### EXAMPLE 5

### Further Device Fabrication

Powders of a resistive composition (21.5 vol % MoSi₂, 5 vol % SiC, remainder Al₂O₃), a conductive composition (28 vol % MoSi2, 7 vol % SiC, remainder Al₂O₃) and insulating composition (10 vol % MoSi₂, remainder Al₂O₃) were mixed with about 12 wt % paraffin-wax based binder to form three pastes with about 64 vol % solids loading. A higher melting wax composition was used to increase the thermal stability of the green (as-molded) the first shot i.e. supporting member (in this case the insulating component). The three pastes were loaded into the barrels of a co-injection molder to whose mold-frame were attached the three cavities corresponding to each shot. The first shot filled a cavity that had a nearly rectangular cross-section tapering along the length in both directions with the insulating paste, forming the supporting member. The part was removed from the first cavity and placed in a second cavity. The second shot filled a cavity bounded by the first shot and the cavity wall with the conductive paste. The part was removed from the second cavity and placed in a third cavity. A third shot filled the volume bounded by the first shot, second shot and the cavity wall with the resistive paste forming a hair-pin shaped section separated by the insulating support and connected to the conductive sections also separated by the insulating support. The molded part was partially debindered in tap water removing 3-4 wt % of the added 12 wt % binder. The part was then thermally debindered in flowing Argon at 300° C. to 500 C for 24 h to remove the remaining binder and densified to greater than 97% of theoretical density by gas pressure sintering at 1750° C. under maximum pressure of 3000 psi. When the conductive legs of the densified igniter are connected to a power supply of voltage 12V, the hot-zone (i.e. the resistive zone) attained a temperature of 1280-1320° C.

The invention has been described in detail with reference to particular embodiments thereof. However, it will be appreciated that those skilled in the art, upon consideration of this disclosure, may make modification and improvements within the spirit and scope of the invention.

1. A method for producing a ceramic element, comprising injection molding three or more portions of the ceramic element.

2. The method of claim 1 wherein the ceramic element comprises two or more regions having differing ceramic compositions.

3. The method of claim 1 wherein the ceramic element comprises three or more regions having differing ceramic compositions.

4. The method of claim 2 wherein the two or more regions comprise ceramic compositions that differ in electrical resistivity and/or optical transmission.

5. The method of claim 3 wherein the three or more regions comprise ceramic compositions that differ in electrical resistivity and/or optical transmission.

6. The method of claim 1 wherein two or more of the injected molded element portions are positioned at opposing angles.

7. The method of claim 1 wherein a support element, electrical connection device, shielding, thermal sensor device, or optical sensor device comprises the ceramic element.

8. The method of claim 1 wherein a semiconductor device, opto-electronic device or sensing element comprises the ceramic element.

9. The method of claim 1 further comprising applying one or more ceramic compositions to at least a portion of the formed ceramic element.

10. The method of claim 1 further comprising applying one or more metal compositions to at least a portion of the formed ceramic element.

11. The method of claim 1 further comprising densifying the formed ceramic element.

12. The method of claim 1 further comprising removing a portion of the formed ceramic element.

13. A method for producing a ceramic element, comprising injection molding two or more distinct portions of the ceramic element,
wherein the ceramic element is or is a component of a bearing, support or structural element; electrical connection element; a shielding element; a thermal, gas or optical sensor; a semiconductor device; opto-electronic device; gas injector device; microfluidic device; or a piezoelectric device.

14. The method of claim 13 wherein three or more distinct portions of the ceramic element are injection molded.

15. The method of claim 1 or 13 wherein the ceramic element is not a component of a resistive igniter device.

16. A ceramic element obtainable by a method of claim 1 or 13.

17. The ceramic element of claim 16 wherein the element comprises two or more regions of differing resistivity and/or optical transmission.

18. The ceramic element of claim 16 wherein the element comprises three or more regions of differing resistivity and/or optical transmission.

19. The ceramic element of claim 16 wherein two or more of the injected molded element portions are positioned at opposing angles.

20. The ceramic element of claim 16 wherein a support element, electrical connection device, shielding, thermal sensor device, or optical sensor device comprises the ceramic element.

21. The ceramic element of claim 16 wherein a semiconductor device, opto-electronic device or sensing element comprises the ceramic element.
